(19) United States
(12) Patent Application Publication
(10) Pub. No.: US 2006/0227538 A1
(43) Pub. Date: Oct. 12, 2006

(54) Illuminated purse

(76) Inventor: William Royce Williams, Nashville, TN (US)

Correspondence Address: JAMES ADDISON BARRY, JR., 105 GLENWAY POINT, LEBANON, TN, 37087, US

(21) Appl. No.: 11/390,047

(22) Filed: Mar. 27, 2006

Related U.S. Application Data
(60) Provisional application No. 60/669,071, filed on Apr. 7, 2005.
(60) Provisional application No. 60/672,373, filed on Apr. 18, 2005.

(51) Int. Cl. F21V 33/00

(52) U.S. Cl. 362/155; 362/156

(57) ABSTRACT

An illuminated purse that includes a ladies purse with an interior lighting system comprising a battery source, a magnetic switching means, a LED lighting means arranged in a vertical strip of 3 to 10 lights located in the lining of the four comers of the purse to illuminate the corners of the purse. The Strip may also be mounted horizontally at tile top, bottom, or center of the purse depending on the design.

### CROSS-REFERENCE

This application claims the benefit of U.S. Provisional Application Ser. No. 60/669,07 1, filed Apr. 07, 2005, titled Illuminated Purse or Handbag Lining and U.S. Provisional Application Ser. No. 60/672,373, filed Apr. 18, 2005, titled Illuminated Purse or Handbag Lining. The present application is related by the same inventor for all applications, William Royce Williams. The U.S. Provisional Applications Ser. No. 60/669,071, filed Apr. 07, 2005 and No. 60/672,373, Filed Apr. 18, 2005 are hereby incorporated in its entirety by reference.

### BACKGROUND

(1) Technical Field

The present invention relates to an illuminated purse or handbag lining. More particularly, this invention relates to a purse with an interior lighting system that automatically turns the lights on and off when the purse is opened and closed.

(2) Background

Purses are convenient for carrying many items. However, it can be difficult to find particular items in the dark. U.S. Pat. No. 6,824,291 filed Jan. 17, 2003 is one attempt and U.S. Pat. No. 6,824,291 lists approximately 35 other U.S. Patents that were also attempts to illuminate handbags, purses and containers. Despite all of these attempts there still exists a need to provide adequate lighting for a purse. It would desirable, therefore to have a purse with an automatic illumination system to turn the lights within a purse on and off as the purse is opened and closed.

### SUMMARY OF THE INVENTION

The present invention is a purse or handbag with an automatic illumination system to turn lights on and off within a purse as the purse is opened and closed.

### BRIEF DESCRIPTION OF THE DRAWINGS

The objects, features and advantages of the present invention will be apparent from the following detailed descriptions of various aspects of the invention in conjunction with reference to the following drawings, where:

FIG. 1 is a side cut away view of one embodiment of the present invention depicting the illuminated purse in the closed position.

FIG. 2 is a side cut away view of the present invention depicting the illuminated purse in the open position.

FIG. 3 is a top view of one embodiment of the present invention depicting the illuminated purse with the inner lining not shown and the lights in a vertical position.

FIG. 4 is a cut away view of the present invention depicting the one embodiment of the light installation.

FIG. 5 is a top view of one embodiment of the present invention depicting the illuminated purse with the inner lining not shown and the lights in a horizontal position.

FIG. 6 is a side cut away view of one embodiment of the present invention depicting the illuminated purse with horizontal light rows.

### DETAILED DESCRIPTION

The present invention is an Illuminated Purse to illuminate the four corners of the purse. The following description, taken in conjunction with the referenced drawings, is presented to enable one of ordinary skill in the art to make and use the invention and to incorporate it in the context of particular applications. Various modifications, as well as a variety of uses in different applications, will be readily apparent to those skilled in the art, and the general principles defined herein, may be applied to a wide range of aspects. Thus, the present invention is not intended to be limited to the aspects presented, but is to be accorded the widest scope consistent with the principles and novel features disclosed herein. furthermore, it should be noted that, unless explicitly stated otherwise, the figures included herein are illustrated diagrammatically and without any specific scale, as they are provided as qualitative illustrations of the concept of the present invention.

(1) Introduction

The present invention is an illuminated purse. It is the object of the invention to illuminate the interior of the purse. The illuminated purse may include a ladies purse or handbag with an interior lighting system that includes a battery source, a magnetic switching means, a LED lighting means arranged in a vertical or horizontal strip or row lights located in the lining of the purse or handbag. The strip or row can be mounted vertically in the corner or horizontally at the top, bottom, or center of the purse or handbag depending on the purse design. This will allow the entire purse to be illuminated from top to bottom allowing the user to better see the contents or said purse or handbag.

(2) Discussion

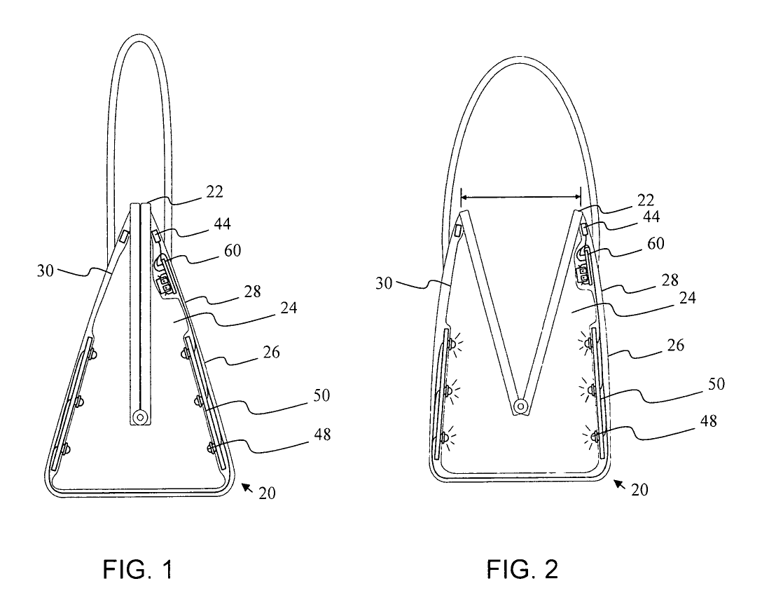

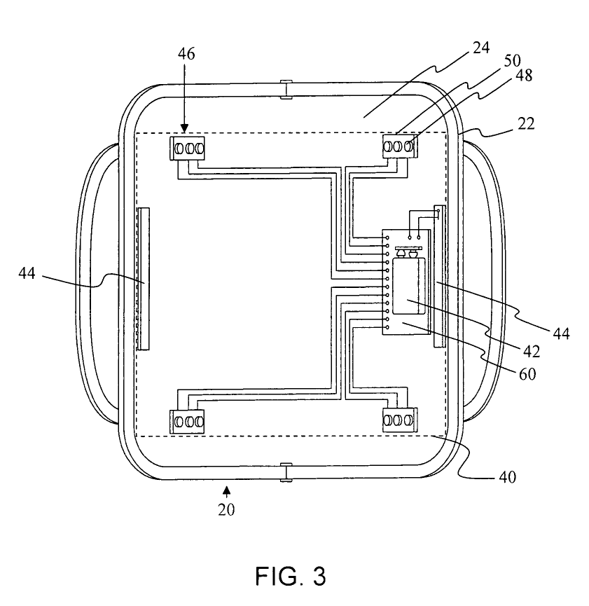

One embodiment of the illuminated purse is shown in FIG. 1 with the purse closed and in FIG. 2 with the purse opened and the lights illuminated. The present invention as depicted includes a purse 20 comprising a top edge 22 that will open and close to allow access to an interior 24 of the purse. The corners 26 of the purse may extend to the top edge 22 of the purse. An outer bag 28 extends between the corners 26 of the purse 20, and an inner lining 30 is disposed inside of the outer bag 28. The present invention also includes an illumination system 40 as further depicted in FIG. 3 that comprises a battery source 42 for supplying electrical energy for the illumination system 40, a magnetic switching means 44 electrically connected to the battery source 42, and a LED lighting means 46 electrically connected to the magnetic switching means 44 wherein the LED lighting means 46 comprises between 3 and 10 LED lights 48 disposed in a row attached with the inner lining 30. The battery source 42 may include at least one replaceable battery 42 with access through the inner lining 30 of the purse 20 to replace the battery 42. The magnetic switching means 44 illuminates the between 3 and 10 LED lights 48 when the top edge 22 of the purse 20 is opened and the magnetic switching means 44 removes the electrical energy for illumination when the purse 20 is closed.

The embodiment of the present invention depicted in FIGS. 1, 2, and 3 shows an embodiment where the illumination system LED lighting means 46 is disposed in a vertical row 50 in the one or all of the corners 26 of the purse 20. The positioning of between 3 and 10 LED lights in a row 48 when positioned in the vertical corners 26 assist in providing good illumination of items in a cluttered purse. The illumination system may include a circuit board 60 for electrical connection and illumination of the LED lights 48 when the magnetic switching means 46 is opened.

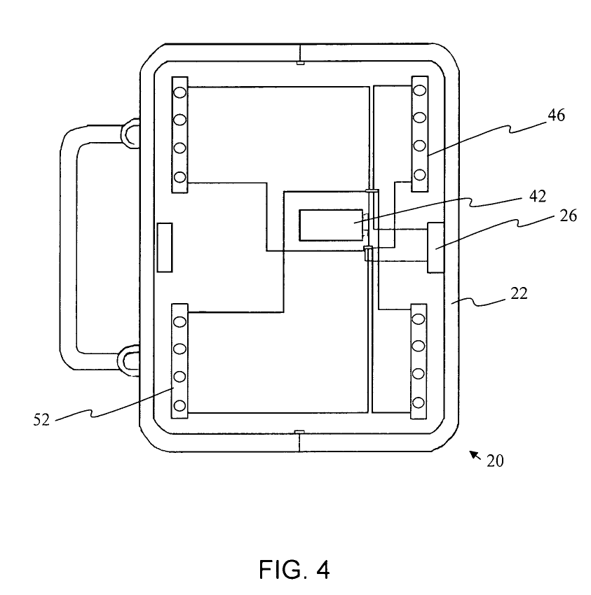

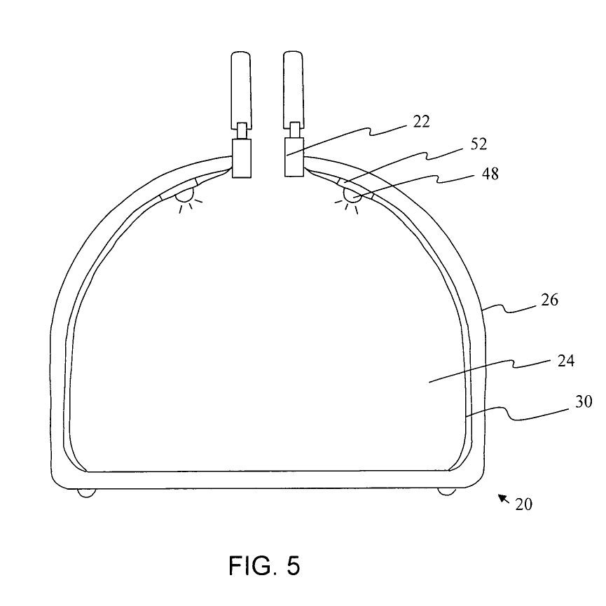

Yet another embodiment of the present invention is depicted in FIG. 4 and FIG. 5. In this embodiment of the illuminated purse, the illumination system LED lighting means 46 are disposed in horizontal rows 52 near the top edge 22 of the purse 20. Horizontal rows 52 near the top edge 22 of the purse 20 are another effective means of illuminating the purse 20 interior 24.

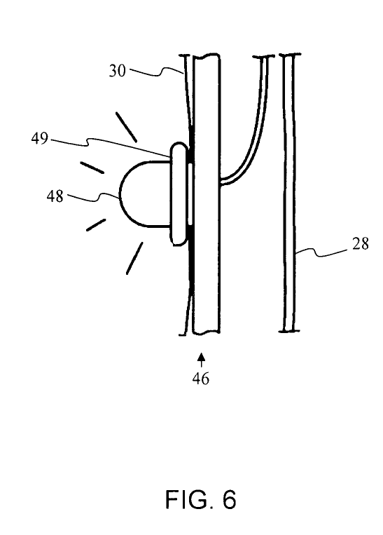

FIG. 6 depicts one embodiment of a light installation. In this embodiment of the light installation, the illumination system LED lighting means 46 is disposed between the outer bag 28 and the inner lining 30. The LED light 48 extends or protrudes through the liner 30 to the purse 20 interior 24 and is held or secured in place by an O-ring 49.

What is claimed is:

1. An illuminated purse comprising:
a purse comprising:
a top edge that will open and close to allow access to an interior of the purse,
four corners of the purse that extend to the top edge of the purse,
an outer bag that extends between the four corners of the purse,
an inner lining disposed inside of the outer bag; and
an illumination system comprising:
a battery source for supplying electrical energy for the illumination system,
a magnetic switching means electrically connected to the battery source, and
a LED lighting means electrically connected to the magnetic switching
means wherein the LED lighting means is disposed between the outer bag
and the inner lining and the LED lighting means comprises between 3 and 10 LED lights disposed in a row attached with the inner lining wherein the between 3 and 10 LED lights protrude through the inner liner into the interior of the purse to allow illumination of interior of the purse wherein the magnetic switching means illuminates the between 3 and 10 LED lights when the top edge of the purse is opened and removes the electrical energy for illumination when the purse is closed.

2. An illuminated purse as set forth in claim 1, wherein the illumination system LED lighting means further comprises a vertical row disposed in the corner of the purse.

3. An illuminated purse as set forth in claim 1, wherein the illumination system LED lighting means further comprise vertical rows disposed in each of the corners of the purse.

4. An illuminated purse as set forth in Claim 1, wherein the illumination system LED lighting means further comprise a horizontal row attached with the lining of the purse.

5. An illuminated purse as set forth in claim 4, wherein the horizontal rows are disposed near the top edge of the purse.

6. An illuminated purse as set forth in claim 4, wherein the horizontal rows are disposed near the center of the purse.

7. An illuminated purse as set forth in claim 4, wherein the horizontal rows are disposed near bottom of the purse.

8. An illuminated purse as set forth in Claim 1, wherein the illumination system further comprises a circuit board for electrical connection.

9. An illuminated purse as set forth in claim 1, wherein the battery source further comprises at least one replaceable battery.

10. An illuminated purse as set forth in Claim 1, wherein the LED lighting means attachment with the inner lining comprises an O-ring disposed around the LED light to secure the LED lighting means in place with the inner lining.
